(19) United States
(12) Patent Application Publication
(10) Pub. No.: US 2006/0221039 A1
(43) Pub. Date: Oct. 5, 2006

(54) Liquid crystal display device and large scale liquid crystal display system using the same

(75) Inventor: Kazuhiro Ishiguchi, Kumamoto (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, TOKYO (JP)

(21) Appl. No.: 11/386,746

(22) Filed: Mar. 23, 2006

(30) Foreign Application Priority Data
Apr. 1, 2005 (JP) 2005-105694

(51) Int. Cl. G09G 3/36

(52) U.S. Cl. 345/98

(57) ABSTRACT

A liquid crystal display device includes a first substrate (transparent substrate), a second substrate (transparent substrate) placed opposite to the first substrate, a liquid crystal which is held between the first substrate and the second substrate, and a driving circuit which is provided in each of pixels on the first substrate for driving the liquid crystal, and a photoelectric power generation element which is provided in each of the pixels or each set including some pixels, for supplying generated power for driving the liquid crystal.

### BACKGROUND OF THE INVENTION

1. Field of the Invention

The present invention relates to a liquid crystal display device and to a large scale liquid crystal display system using the liquid crystal display device, and more particularly to a liquid crystal display device which allows for increases in size and resolution and reduction in power consumption and to a large scale liquid crystal display system using the foregoing liquid crystal display device.

2. Description of the Background Art

A liquid crystal display device is a device which controls light by using a liquid crystal as an optical shutter, to thereby display a desired image. In other words, a liquid crystal display device is a non-self-luminous display device, unlike a plasma display device or an organic electro-luminescent (EL) display device which is self-luminous. As such, a liquid crystal display device requires a light source. A transmission liquid crystal display device which is generally used in a personal computer (PC) is provided with a light source on a back face thereof. Such light source is called a back light. On the other hand, a refection liquid crystal display device or the like which is used in a mobile computer and the like is provided with a light source on a front face thereof. Such light source is called a front light. Otherwise, a reflection liquid crystal display device utilizes external light as a light source.

A liquid crystal display device, in general, consumes little electric power. In particular, power consumption of a part functioning as a liquid crystal panel except a light source is extremely low. For this reason, a reflection liquid crystal display device which does not require a light source has been adopted for a wide range of battery-powered apparatuses.

Further, because of advances made on a liquid crystal display devices, such as a shift from a segment method to a matrix method and a shift from passive drive to active drive, the size and the resolution of a liquid crystal display device are ever-increasing. However, increases in size and resolution of a liquid crystal display device conflicts low power consumption which is one of properties of a liquid crystal display device. An increase in size of a liquid crystal display device invites an increase in length of a source line or a gate line, and thus invites an increase in line capacitance of the source line or the gate line, to cause a problem of increasing power consumption.

Also, an increase in resolution of a liquid crystal display device invites an increase in the number of changes of a voltage of a source line or a gate line in a cycle of a single frame, to cause a problem of increasing power consumption. Further, increases in size and resolution of a liquid crystal display device invites an increase in delay of a signal fed to each line. Such increased signal delay causes another problem of failing to apply a predetermined voltage to a liquid crystal in a predetermined time in a case where a device is driven from one end of a source line or a gate line.

In view of the foregoing, Japanese Patent Application Laid-Open Nos. 2001-184033 and 2004-191645 (which will hereinafter be referred to as “JP No. 2001-184033” and “JP No. 2004-191645”) suggest a liquid crystal display device which is provided with a solar battery in order to achieve low power consumption.

However, it is impossible to prevent an increase in power consumption and signal delay which are likely to be caused due to increases in size and resolution of a liquid crystal display device by merely providing a solar battery as suggested in JP Nos. 2001-184033 and 2004-191645. Moreover, further increases in size and resolution of a liquid crystal display device would require taking some countermeasures such as increasing the size of a solar battery.

### SUMMARY OF THE INVENTION

It is an object of the present invention to provide a liquid crystal display device which allows for low power consumption even with increases in size and resolution of the liquid crystal display device, and a large scale liquid crystal display system using the foregoing liquid crystal display device

A liquid crystal display device according to the present invention includes a first substrate, a second substrate, a liquid crystal, plural driving circuits, and plural photoelectric power generation elements. The liquid crystal is held between the first substrate and the second substrate. The plural driving circuits are respectively provided in plural pixels on the first substrate, for driving the liquid crystal. The plural photoelectric power generation elements are respectively provided for either the plural pixels or plural sets each including some of the plural pixels, for generating power and supplying a voltage to drive the liquid crystal.

The liquid crystal display device according to the present invention allows for reduction in power consumption even with increases in size and resolution of the liquid crystal display device because of inclusion of the photoelectric power generation elements which are respectively provided in the pixels and supply generated power to the pixels and the driving circuits.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a sectional view of a liquid crystal display device according to a first preferred embodiment of the present invention.

FIG. 2 is a circuit diagram of the liquid crystal display device according to the first preferred embodiment of the present invention.

FIG. 3 is a circuit diagram illustrating a part of a driving circuit according to the first preferred embodiment of the present invention.

FIG. 4 shows transmittivity characteristics of filters according to the first preferred embodiment of the present invention.

FIG. 5 is a waveform diagram of the driving circuit according to the first preferred embodiment of the present invention.

FIG. 6 is a view for explaining transmission of a starting pulse signal according to the first preferred embodiment of the present invention.

FIG. 7 is a view for explaining how lines are laid in the liquid crystal display device according to the first preferred embodiment of the present invention.

FIG. 8 is a plan view of a large scale liquid crystal display system including tiled liquid crystal display devices according to the first preferred embodiment of the present invention.

FIG. 9 is a waveform diagram of driving circuit according to a third preferred embodiment of the present invention.

FIGS. 10, 11, and 12 are circuit diagrams of a liquid crystal display device according to the third preferred embodiment of the present invention.

FIG. 13 is a circuit diagram illustrating a part of the driving circuit according to the third preferred embodiment of the present invention.

FIG. 14 is another waveform diagram of the driving circuit according to the third preferred embodiment of the present invention.

FIGS. 15, 16, and 17 are circuit diagrams of a liquid crystal display device according to a fourth preferred embodiment of the present invention.

FIG. 18 is a waveform diagram of a driving circuit according to a fifth preferred embodiment of the present invention.

FIG. 19 is a sectional view of a liquid crystal display device according to a sixth preferred embodiment of the present invention.

FIGS. 20 and 21 are plan views of the liquid crystal display device according to the sixth preferred embodiment of the present invention.

### DESCRIPTION OF THE PREFERRED EMBODIMENTS

### Preferred Embodiments

### First Preferred Embodiment

In a first preferred embodiment of the present invention, a transmission liquid crystal display device in which a back light serves as a light source and a voltage is applied in a direction perpendicular to a screen of the display device will be described. However, a liquid crystal display device according to the present invention is not limited to the liquid crystal display device which will be described in the first preferred embodiment. The present invention encompasses a liquid crystal display device in which a voltage is applied in a direction parallel to a screen of the display device (an in-plane switching (IPS) liquid crystal display device, for example), a reflection liquid crystal display device, and so on.

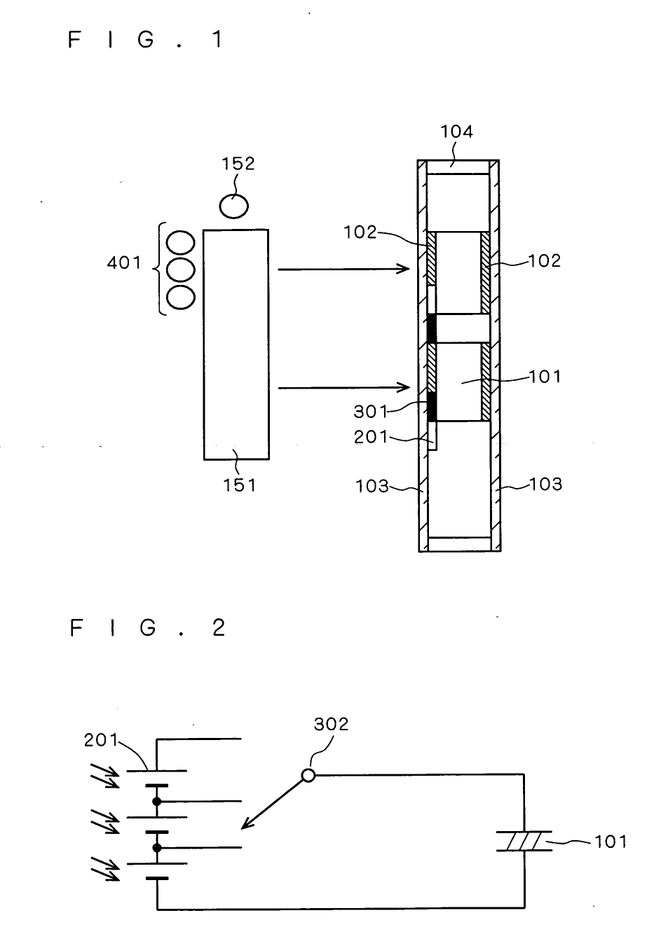

FIG. 1 is a sectional view of the liquid crystal display device according to the first preferred embodiment. In the liquid crystal display device illustrated in FIG. 1, a liquid crystal 101 is held between transparent electrodes 102 (indium tin oxide (ITO), for example) which oppose each other in each of pixels. The transparent electrodes 102 are formed on a pair of transparent substrates 103 formed of glass or the like, respectively. The pair of transparent substrates 103 are stuck to each other by a sealing material 104. One of the pair of transparent substrates 103 is provided with a driving circuit 301 for driving the liquid crystal 101, in each of the pixels. On the other hand, the other of the pair of transparent substrates 103 is provided with a color filter (not illustrated) for displaying a colored image in some cases.

The liquid crystal display device according to the first preferred embodiment includes serially-connected photoelectric power generation elements 201 which are located in peripheral portions of the pixels on one of the transparent substrates 103 on which the driving circuits 301 are formed. The photoelectric power generation elements 201 are connected to the driving circuits 301 and the transparent electrodes 102. The photoelectric power generation elements 201 are located near openings of the pixels through which light from the back light passes. In other words, the photoelectric power generation elements 201 are located in a position where a black matrix (which will hereinafter be also referred to as “BM”) is supposed to be located in a typical liquid crystal display device.

The back light according to the first preferred embodiment includes a main light source 152 (a cold cathode fluorescent lamp (CCFL), for example) for general use and a light emitting diode (LED) 401 which is distinct from the main light source 152 and emits light having a specific wavelength. The LED 401 is a light source for control (an electromagnetic-wave source for control), and supplies light (an electromagnetic wave) functioning as a control signal for the driving circuits 301. Light supplied from the main light source 152 and light (an electromagnetic wave) supplied from the LED 401 are mixed with each other in an optical waveguide 151, and then are supplied to a liquid crystal panel. Thus, it is unnecessary to additionally provide a member for supplying light from the LED 401 to an entire surface of the liquid crystal panel.

Each of the photoelectric power generation elements 201 according to the first preferred embodiment is a photovoltaic element in terms of property. Such property can be prominently exhibited by a semiconductor formed of a PIN junction. It is noted that a PIN junction is a junction having a structure in which an un-doped layer (i-type layer) is formed between a p-type layer and an n-type layer in order to suppress re-combination of minor carriers. A PIN junction is widely used in an amorphous silicon solar battery. In the meantime, each of the photoelectric power generation elements 201 can be obtained by either newly forming a photoelectric power generation element on the transparent substrate 103 or mounting a photoelectric power generation element which has been manufactured in a separate place onto the transparent substrate 103.

The driving circuits 301 according to the first preferred embodiment can be formed and incorporated into the liquid crystal display device during manufacture of a thin film transistor (TFT) formed of amorphous silicon or polysilicon in the same manner as in existing TFT liquid crystal panels.

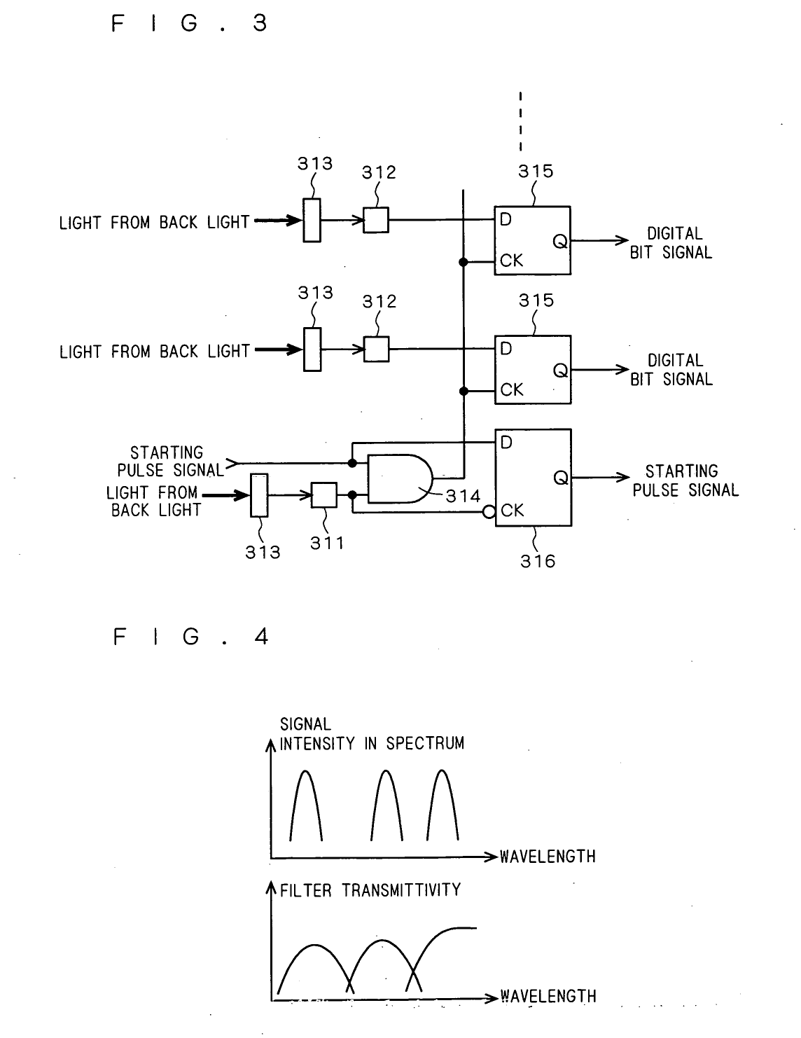

Below, operations of the liquid crystal display device according to the first preferred embodiment will be described. First, each of the photoelectric power generation elements 201 receives light from the back light (light from the main light source) and generates electric power. A voltage resulted from the generated electric power is supplied to the driving circuit 301, where adjustment is made so as to obtain a desired voltage. Thereafter, the desired voltage is applied to the liquid crystal 101. A voltage generated by a single cell of the photoelectric power generation element 201 is low, as generally known. Thus, when a voltage on the order of several volts is required, series connection of some cells is used. If each of the photoelectric power generation elements 201 is capable of generating a high voltage, only a single cell may be provided in each of the pixels though such structure is not illustrated in the drawings. FIG. 2 is a diagrammatic view illustrating a state where a voltage generated by the photoelectric power generation elements 201 is applied to the liquid crystal 101. FIG. 2 illustrates that a desired voltage is taken from three serially-connected cells of photoelectric power generation elements 201 by a multiplexer 302 and applied to the liquid crystal 101.

In the photoelectric power generation elements 201 under normal conditions, an output voltage provided under illumination with a given light intensity decreases as an output current increases. However, when an output voltage is applied to the liquid crystal 101, no current flows after charging is finished because the liquid crystal 101 is regarded as equivalent to a condenser. Accordingly, a voltage which is ultimately obtained and applied to the liquid crystal 101 is equal to a saturation voltage of the photoelectric power generation elements 201. The saturation voltage of the photoelectric power generation elements 201 does not so greatly depend on a light intensity. When the dependency of the saturation voltage on a light intensity is negligible, light of the back light can be adjusted (dimming) without providing a voltage regulator. Additionally, one photoelectric power generation element 201 may be either provided in each of the pixels, or shared by some pixels surrounding the one photoelectric power generation element 201.

Then, in order to cause the liquid crystal display device to display an image, it is necessary to send a predetermined control signal to the driving circuit 301 in each of the pixels. Sending of a control signal can be implemented by laying a source line and a gate line within the liquid crystal panel in the same manner as in the conventional liquid crystal display device. However, as explained above in the “Background Art” section, to lay a source line and a gate line is likely to cause a problem of increasing power consumption because of an increase in line capacitance or the like in a case where the size and the resolution of the device are increased. Thus, in the liquid crystal display device according to the first preferred embodiment, a predetermined control signal is transmitted to the driving circuit 301 in each of the pixels by a method which allows for reduction in power consumption.

More specifically, in the liquid crystal display device according to the first preferred embodiment, a control signal is transmitted to the driving circuit 301 in each of the pixels using light for control (which will hereinafter be also simply referred to as an electromagnetic wave) without laying a source line or a gate line within the liquid crystal panel. To this end, the liquid crystal display device according to the first preferred embodiment requires provision of a demodulator for demodulating an electromagnetic wave transmitted to the driving circuit 301 in each of the pixels. Further, as a result of provision of a demodulator, a member for selecting an electromagnetic wave having a specific frequency (an optical filter, for example) and a member for taking out a necessary signal from the selected electromagnetic wave (an optical sensor, for example) are required. It is additionally noted that in a case where a short wavelength typified by a wavelength of a light is dealt with, a physical frequency selector can be utilized.

However, to allocate a carrier frequency to each of the pixels in controlling the driving circuit 301 in the liquid crystal display device is inefficient because the number of the pixels is extremely large. Hence, in the liquid crystal display device according to the first preferred embodiment, only a starting pulse signal serving as a timing for applying a voltage to a pixel is transmitted through a line laid between adjacent pixels, and a clock signal serving as a timing for controlling the driving circuit 301 and a data signal applied to each of the pixels are generated by using electromagnetic waves. The clock signal and the data signal are generated by using electromagnetic waves having different frequencies (wavelengths), respectively.

More specifically, according to the first preferred embodiment, the clock signal or the data signal are transmitted to the driving circuit 301 using the LED 401 which is provided in the back light and emits light having a specific wavelength. The driving circuit 301 includes an optical sensor 311 for receiving the clock signal and the optical sensor 312 for receiving the data signal as illustrated in FIG. 3. The optical sensors 311 and 312 include respective filters 313 which are capable of selecting respective electromagnetic waves having different wavelengths. It is additionally noted that two optical sensors 312 are provided in an example illustrated in FIG. 3.

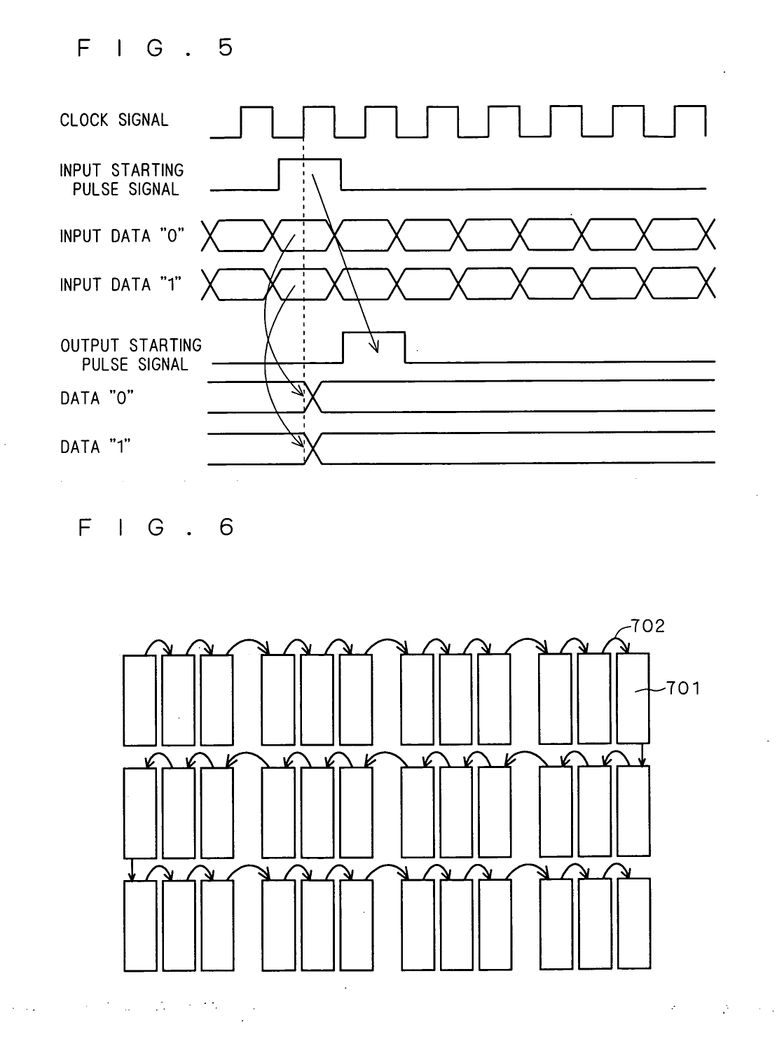

Each of the filter 313 separates light (an electromagnetic wave) for control which is mixed with light from the main light source 152 in the optical waveguide 151, from light from the back light. For the filters 313, a typical color filter or an interface filter such as a prism or a slit can be used. FIG. 4 shows transmittivity characteristics of three different filters with respect to three different wavelengths. By employing the three filters having the transmittivity characteristics shown in FIG. 4, it is possible to separate light (electromagnetic wave) for control into rays having respective wavelengths.

As described above, the light source for control is the LED 401. The wavelength of light which is considered to be suitable as light emitted from the LED 401 is in a range from approximately 300 nm to 1 μm which corresponds to a wavelength range from ultraviolet to infrared. It is desirable to use light having a wavelength outside a visible light range, such as ultraviolet light or infrared light, in order to avoid any influence on displayed images whatever pattern the control signal would have. If a light source which emits visible light is used as the light source for control, a ratio between a lighting time and a non-lighting time changes in accordance with a pattern of the control signal, to likely affect displayed images. However, in a case where the sensitivities of the optical sensors 311 and 312 are sufficiently higher than a luminosity factor, in other words, in a case where it is almost impossible to visually recognize whether or not the light (electromagnetic wave) for control lights up on the screen, displayed images are not affected even if the ratio between the lighting time and the non-lighting time changes. It is additionally noted that in the case where the sensitivities of the optical sensors 311 and 312 are sufficiently higher than a luminosity factor, it is preferable to employ light having a wavelength corresponding to a low intensity in the spectrum of light from the main light source 152 because to do so allows an increase in a signal-to-noise ratio.

FIG. 5 is a waveform diagram of a signal which is processed in one of the pixels of the liquid crystal display device according to the first preferred embodiment. For the purposes of explanation, it is assumed that each of the optical sensors 311 and 312 outputs a high level when each of the optical sensors 311 and 312 receives selected light while each of the optical sensors 311 and 312 outputs a low level when each of the optical sensors 311 and 312 receives no light. First, upon blinking of the LED 401 for generating a clock signal, the optical sensor 311 receives light emitted from the LED 401 via the filter 313, and generates a clock signal, in each of the pixels at the same time. Though not illustrated in FIG. 3, in the first pixel into which data is first written, the optical sensor further receives light from the LED 401 for generating a starting pulse signal, and generates a starting pulse signal, also. The generated starting pulse signal is transmitted to a pixel next to the first pixel via a line laid between the two pixels, and is further transmitted sequentially in the same manner.

When a starting pulse signal as illustrated as “INPUT STARTING PULSE SIGNAL” in FIG. 5 is input to one pixel and is latched by an AND gate 314 illustrated in FIG. 3 while retaining a high level, light which is emitted from the LED 401 (for generating a data signal) and is received by the optical sensor 312 is transferred to a register 315. Referring to FIG. 5, when an input starting pulse signal retains a high level and the clock signal rises (at a timing indicated by a broken line in FIG. 5), data “0” and data “1” change based on input data “0” and input data “1” received by the optical sensor 312.

In the example illustrated in FIG. 3, two kinds of optical sensors 312 are provided. As such, two kinds of LEDs 401 for generating a data signal are provided, and a 2-bit voltage (four gradations) which is to be applied can be selected. Digital bit information necessary for digital-to-analog (D/A) conversion is transmitted from the register 315 to the multiplexer 302. Then, the multiplexer 302 selects a predetermined voltage based on the digital bit information and applies the predetermined voltage to the liquid crystal 101.

The driving circuit 301 generates a starting pulse signal for a next pixel in a register 316 illustrated in FIG. 3 after transfer of one data signal is finished. Then, the driving circuit 301 outputs a starting pulse signal as illustrated as “OUTPUT STARTING PULSE SIGNAL” in FIG. 5 to the next pixel cascaded to the one pixel. The same operations as indicated by the waveforms in FIG. 5 are repeated for each of the pixels. Thus, in the liquid crystal display device according to the first preferred embodiment, the same data is held after the first starting pulse signal is input and before the second starting pulse signal is input (in other words, during one refreshing period) in each of the pixels.

Therefore, unlike a commonly-used liquid crystal display device which requires that a predetermined voltage be applied to a pixel within at least a period for horizontal scanning of one line (“one horizontal scanning period”), a time for data writing (application of a predetermined voltage) is not limited to one horizontal scanning period in the liquid crystal display device according to the first preferred embodiment. Data writing can be carried out until the second starting pulse signal is input, so that a longer time for charging can be given. Hence, even if the photoelectric power generation elements 201 have a poor power generation capability, the size of each of the photoelectric power generation elements 201 can be reduced because charging can be performed for a long time (several milliseconds). Further, also power for turning on the driving circuit 301 provided in each of the pixels is supplied from the photoelectric power generation elements 201 in the liquid crystal display device according to the first preferred embodiment.

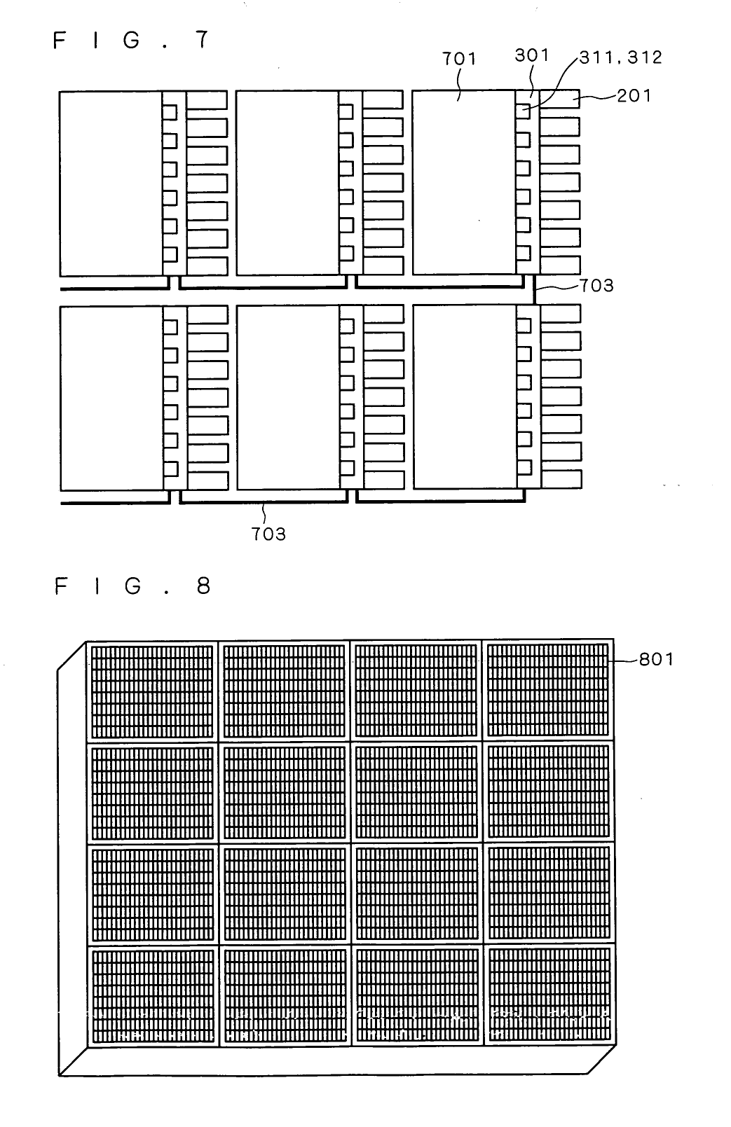

As described above, a starting pulse signal is transmitted between adjacent pixels via an electric line. As generally known, for control of pixels in a matrix display device, after one line is scanned from the left to the right, feedback to the left of a next line is provided. However, in order to provide feedback of a starting pulse signal from the right of one line to the left of a next line in the liquid crystal display device according to the first preferred embodiment, a long line is required. As such, a starting pulse signal is transmitted via a path which runs as if it were drawn with a single stroke of brush, as illustrated in FIG. 6, to thereby achieve efficient connecting in the liquid crystal display device according to the first preferred embodiment. It is noted that arrows 702 in FIG. 6 indicate directions of transmission of a starting pulse signal between pixels 701.

More specifically, a starting pulse signal is moved from the left to the right of one line for scanning the one line, and the starting pulse signal is then moved from the right to the left of a next line for scanning the next line in the device according to the first preferred embodiment. Data signals transmitted from the LED 401 for generating a data signal and the like are re-arranged in accordance with the scanning path which runs as if it were drawn with a single stroke of brush. A specific example of arrangement of pixels is illustrated in FIG. 7. FIG. 7 illustrates that each of the pixels 701 and the photoelectric power generation elements 201 are connected via the driving circuit 301, and the driving circuits 301 respectively provided in the pixels 701 adjacent to each other are connected to each other via starting pulse lines 703. It is additionally noted that also the optical sensors 311 and 312 provided in each of the driving circuits 301 are illustrated in FIG. 7.

As described above, only the first pixel into which data is first written, in other words, a pixel corresponding to a starting point of movement of a starting pulse signal, requires an electric line or a dedicated demodulator. In a case where a dedicated demodulator is provided, it is necessary to employ a light source which emits light having a specific wavelength and to additionally provide a filter and an optical sensor for selecting and receiving the light having the specific wavelength in the driving circuit 301. On the other hand, in a case where an electric line is laid, it is necessary to form a structure for connecting the first pixel to an external circuit using the electric line and supplying a starting pulse signal generated in the external circuit to the first pixel.

A possible way of generating a starting pulse signal in the first pixel corresponding to a starting point of movement of a starting pulse signal is to turn off the main light source 152 for a while and detect a signal using a sensor which is additionally prepared for detection, or to turn off the main light source 152 for a while and detect reduction of a voltage generated by the photoelectric power generation elements 201. Otherwise, a starting pulse signal can be generated in the first pixel corresponding to a starting point of movement of a starting pulse signal by creating and using a signal formed of a combination which is conceivable for a typical control signal.

In generating a starting pulse signal in the first pixel corresponding to a starting point of movement of a starting pulse signal, it is more advantageous to choose ways other than a way in which an electric line is laid. By avoiding use of an electric line in generating a starting pulse signal as well as a source line or a gate line, no external wire is connected to the liquid crystal panel. This eliminates a need of providing a connection terminal (approximately several millimeters) used for establishing connection to an external wire in a peripheral portion of the liquid crystal panel. Thus, the outer dimensions of the liquid crystal panel according to the first preferred embodiment can be reduced to the size of the sealing material 104, so that the liquid crystal panel has extremely narrow frames.

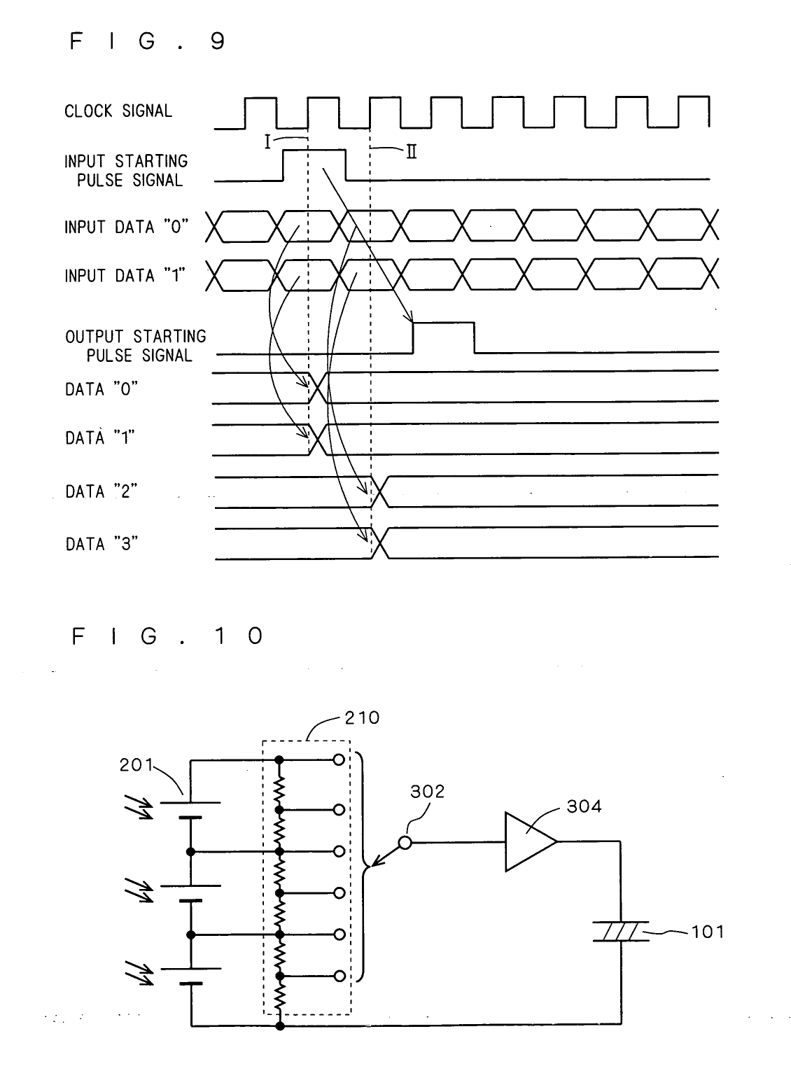

Also, by reducing widths of frames of the back light including the main light source 152 and the light source for control (LED) 401 in the same manner as the widths of the frames of the liquid crystal panel, it is possible to form a large scale liquid crystal display system using the liquid crystal display devices which are closely tiled. FIG. 8 is a schematic representation of closely-tiled liquid crystal display devices. Because of reduction in widths of the frames of the liquid crystal panels of the liquid crystal display devices, influences on displayed images on a joint between the tiled displayed devices can be made smaller. In a case where liquid crystal display devices 801 are tiled as illustrated in FIG. 8, with independent optical systems being provided for respective back lights, each of respective light sources for control of the liquid crystal display devices 801 need not control a liquid crystal panel placed adjacent thereto. For this reason, respective frequencies of the light sources for control can be significantly reduced.

As a specific example, consider a situation where a large scale liquid crystal display system with 1000×1000 pixels is formed by tiling the liquid crystal display devices 801 each with 100×100 pixels. First, in order to control all the 1000×1000 pixels using a single light source for control, there is a need of obtaining a frequency of 60 MHz=60 Hz×1000×1000 if a refresh rate is 60 Hz. However, in a case where each of the liquid crystal display devices 801 each with 100×100 pixels includes an independent light source for control, it is sufficient that each of the independent light sources for control controls pixels at a frequency of 600 kHz=60 Hz×100×100 if a refresh rate is 60 Hz.

Further, in forming an extremely large scale liquid crystal display system without tiling, the size of the liquid crystal display system is governed by a size of mother glass used during manufacture. Even if no concern for the size of mother glass is necessary, the above-noted problem of increasing power consumption due to increases in length of the line and line capacity remains unsolved.

As is made clear from the above description, in the liquid crystal display device according to the first preferred embodiment, a voltage necessary for driving is generated using the photoelectric power generation elements 201 within the liquid crystal panel, and the respective driving circuits 301 are controlled using an electromagnetic wave. This substantially eliminates a need of laying a long line within the device, so that power consumption can be considerably reduced even with increases in size and resolution. Also, in the liquid crystal display device according to the first preferred embodiment, the widths of the frames of the liquid crystal panel can be reduced. Hence, it is possible to easily form a large scale liquid crystal display system by tiling the liquid crystal display devices. Consequently, a high-resolution large scale liquid crystal display system can be formed without being governed by mother glass with respect to size.

Further, in the liquid crystal display device according to the first preferred embodiment, light which is absorbed by the BM in the conventional liquid crystal display device is utilized as power necessary for driving the liquid crystal 101. This makes it possible to reduce power for turning on the liquid crystal panel to substantially zero. Moreover, no wire is connected to the liquid crystal panel in the liquid crystal display device according to the first preferred embodiment. Therefore, the liquid crystal display device according to the first preferred embodiment can be expected to be applied to various uses as a wireless liquid crystal panel.

Although the structure in which the back light includes the light source for control has been described above in the first preferred embodiment, the present invention is not limited to such structure. The present invention covers a structure in which the front light includes a light source for control. Also, in a case where a reflection liquid crystal display device is dealt with, a structure in which either a front light or a back light includes only a light source for control and external light is utilized as a main light source may be employed. Further, the present invention covers a structure in which a back light includes only a main light source and a front light includes a light source for control. It is additionally noted that in the case where a front light includes a main light source or in the case where the reflection liquid crystal display device is dealt with, the photoelectric power generation elements 201 are provided on one of a pair of substrates which is located closer to a screen.

### Second Preferred Embodiment

A typical way of causing a liquid crystal display device to display a colored image is to separate three primary colors from one another using color filters and control respective transmittivities of the color filters independently of one another. By using such way, images can be displayed in various colors. The liquid crystal display device according to the present invention is able to display a colored image in the same manner as noted above. Namely, display of a colored image in the liquid crystal display device according to the present invention can be implemented by providing a color filter for each of the pixels.

In the meantime, when it comes to properties of a photoelectric power generation element, a photoelectric power generation element formed of a thin film has been developed in recent years. Further, such thin-film photoelectric power generation element has the property of allowing light to pass therethrough (in other words, the photoelectric power generation element is light-permeable). In addition, a photoelectric power generation element which is colored has been developed.

A liquid crystal display device according to a second preferred embodiment employs a colored thin-film photoelectric power generation element 201 as a color filter. This eliminates a need of providing a color filter for each of the pixels. Also, there is no need of limiting a region where the photoelectric power generation elements 201 can be placed to a region where BM is supposed to be placed. This allows the photoelectric power generation elements 201 to be placed on openings of the pixels. Thus, the photoelectric power generation elements 201 can be placed in a wider area.

It is noted that colors in a color schedule of sub-pixels are not limited to typical three primary colors, i.e., red (R), green (G), and blue (B) in the liquid crystal display device according to the second preferred embodiment. Also, in the liquid crystal display device according to the second preferred embodiment, transmission of respective control signals for driving the liquid crystal 101 to emit R, G, and B may be carried out either at the same time or in a sequential manner in which R, G, B, R, G . . . , for example, are sequentially emitted.

### Third Preferred Embodiment

In the liquid crystal display device according to the first preferred embodiment, each of the pixels is expressed with four gradations as described above. However, expression with more than four gradations is possible in a typical liquid crystal display device. In view of this, an increase in the number of gradations in a liquid crystal display device will be described in a third preferred embodiment. In short, the number of gradations in a liquid crystal display device can be increased by increasing the number of control signals and subtly adjusting a voltage applied to the liquid crystal 101.

Specifically, first, in order to increase the number of control signals for increasing the number of gradations in a liquid crystal display device, it is necessary to increase the number of data bits of a data signal. To increase the number of data bits in the liquid crystal display device according to the first preferred embodiment would correspondingly increase the required number (of kinds) of light sources for control. Such an increase in the number of light sources for control involves an increase in the number of kinds of optical sensors and optical filters within the driving circuit 301. However, an increase in the number of kinds of light sources for control causes a problem of requiring a band pass filter which operates in a narrower wavelength range.

Then, a liquid crystal display device according to the third preferred embodiment employs a structure in which a plurality of signals are superimposed on a data signal supplied from a single light source for control. More specifically, two optical sensors 312 as illustrated in FIG. 3 are provided in the driving circuit 301 of each of the pixels. The two optical sensors 312 capture data upon receipt of two clock signals. FIG. 9 is a driving waveform diagram of the liquid crystal display device according to the third preferred embodiment. A clock signal, an input starting pulse signal, input data “0”, and input data “1” in FIG. 9 are basically identical to those in FIG. 5, respectively. It is noted that the input data “0” and the input data “1” are pieces of data which are input to the two optical sensors 312, respectively.

The waveforms in FIG. 9 are different from those of FIG. 5 in that an output starting pulse signal is provided after two clock signals are received from a rise time of the input starting pulse signal. In other words, the number of clock signals received during a period for transmitting a data signal (from receipt of the input starting pulse signal to receipt of the output starting pulse signal) in FIG. 9 is twice as that in FIG. 5. As a result, in the liquid crystal display device according to the third preferred embodiment, the data “0” and the data “1” can be captured at a rise time of the first clock signal (see a broken line I in FIG. 9) in the same manner as in the conventional liquid crystal display device, and data “2” and data “3” are newly captured at a rise time of the second clock signal (see a broken line II in FIG. 9). Consequently, data bits, the number of which is twice the number of data bits in the first preferred embodiment (that is, four bits) can be obtained in the third preferred embodiment.

By doubling the number of clock signals received during a period for transmitting a data signal, it is possible to obtain data with gradations, the number of which is twice the number of kinds of light sources for control (for generating a data signal), as described above. Likewise, necessary gradation information can be obtained by increasing the number of clock signals received during a period for transmitting a data signal to the required number. More specifically, in the liquid crystal display device according to the third preferred embodiment, assuming that the number of kinds of light sources for generating a data signal is m and the number of clock signals received during a period for transmitting a data signal is n, data with m×n gradations (bits) can be transmitted. In other words, transmission of a data signal is carried out by a parallel-serial transmission method in the liquid crystal display device according to the third preferred embodiment.

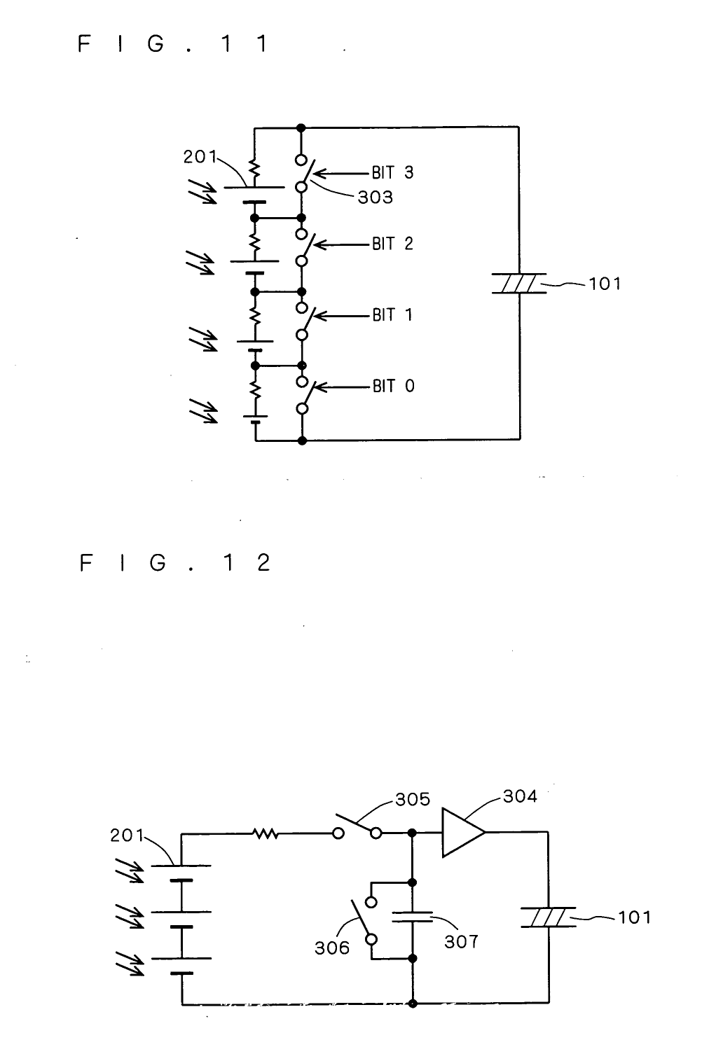

Next, a method of subtly adjusting a voltage applied to the liquid crystal 101 will be described. FIG. 10 illustrates a part of the driving circuit 301 which includes a voltage dividing circuit 210 for dividing a voltage generated by the photoelectric power generation elements 201 and the multiplexer 302 for selecting the voltage dividing circuit 210. Though the voltage dividing circuit 210 illustrated in FIG. 10 is a simple type that employs a resistor for dividing a voltage as one example, various components other than a resistor may be employed for forming the voltage dividing circuit 210 in the present invention. Also, though a buffer 304 serving as a voltage follower or the like is provided in the stage subsequent to the multiplexer 302 in FIG. 10, the buffer 304 is not necessarily required if writing into the liquid crystal 101 (charging) can be finished in a desired time.

FIG. 11 is a view for explaining an alternative method of subtly adjusting a voltage applied to the liquid crystal 101. FIG. 11 illustrates a structure in which a resistor is provided for each of the photoelectric power generation elements 201 which are serially connected to one another. It is noted that the resistor may be formed either outside each of the photoelectric power generation elements 201 or within each of the photoelectric power generation elements 201 as an internal resistor. Also, different sizes of symbols for the photoelectric power generation elements 201 in FIG. 11 represent differences in saturation voltage. For example, respective saturation voltages of the photoelectric power generation elements 201 illustrated in FIG. 11 are 8V, 4V, 2V, and 1V, starting from the top of the figure.

Each of the photoelectric power generation elements 201 is connected in parallel with a switch 303. The switch 303 can be turned on with a much lower resistance value than that of the resistor provided for each of the photoelectric power generation elements 201. Additionally, the switches 303 illustrated in FIG. 11 are represented as “BIT 3”, “BIT 2”, “BIT 1”, and “BIT 0”, starting from the top of the figure. When all the switches 303 are open, a voltage of 15V is applied to the liquid crystal 101. Then, when the “BIT 3” switch 303 is closed, for example, a voltage of 7V is applied to the liquid crystal 101.

Namely, when any (either single or plural) of the switches 303 is closed to cause a short circuit, a voltage equal to 15V minus a volt(s) of the saturation voltage of the photoelectric power generation element 201 to which the closed switch 303 is connected is applied to the liquid crystal 101. By employing a circuit structure illustrated in FIG. 11, it is possible to achieve an ability to divide a voltage equal to the smallest saturation voltage. Meanwhile, a saturation voltage can be reduced by adjusting the properties of the photoelectric power generation elements 201. Otherwise, to insert an additional resistor (not illustrated) which is connected in parallel with each of the photoelectric power generation elements 201 and each of the resistors allows a voltage equal to or smaller than the saturation voltage of the photoelectric power generation elements 201 to be taken out even in a state in which the switches 303 are open.

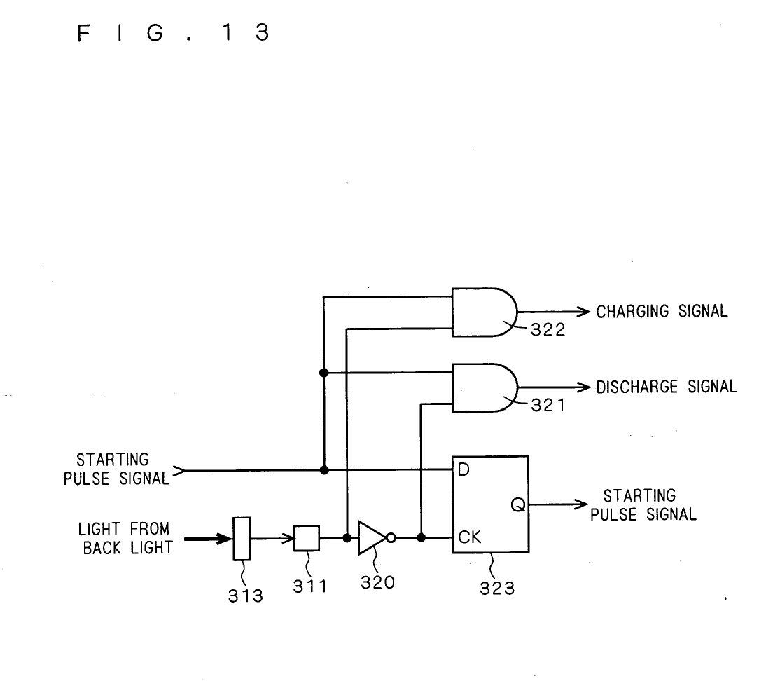

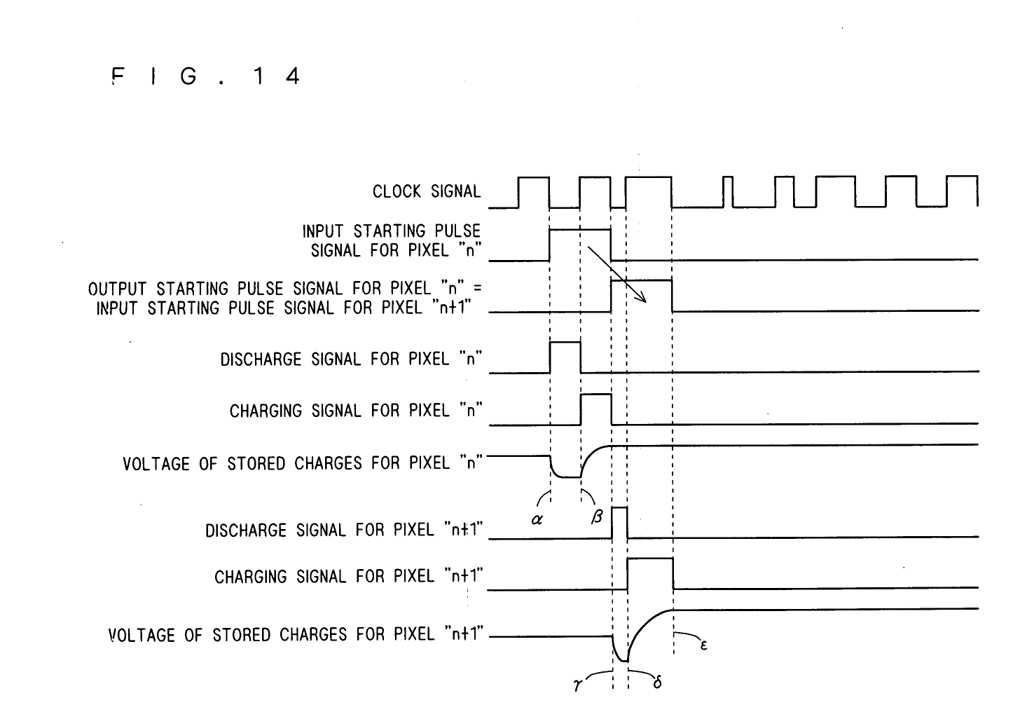

FIG. 12 is a view for explaining another alternative method of subtly adjusting a voltage applied to the liquid crystal 101. A circuit structure illustrated in FIG. 12 is formed by making modifications so as to perform a sample-and-hold function in place of D/A conversion. FIG. 13 is a circuit diagram of a light receiving system of a light source for control which is adapted to the circuit structure illustrated in FIG. 12. Further, FIG. 14 is a diagram of a driving waveform provided in a circuit illustrated in FIG. 13. It is possible to apply an arbitrary voltage to the liquid crystal 101 also by forming the driving circuit 301 as illustrated in FIGS. 12, 13, and 14.

The waveforms in FIG. 14 are different from those in FIG. 5 in that a data signal is not provided and each of a time during which a clock signal retains a high level (“high-level time”) and a time during which a clock signal retains a low level (“low-level time”) is not constant. For the following description, it is assumed that a starting pulse signal is transmitted via an electric line laid between adjacent pixels in the structure illustrated in FIGS. 12, 13, and 13. Then, a starting pulse signal transmitted from a pixel “n−1” is input to a pixel “n”, as an input starting pulse signal, as illustrated in FIG. 14. Subsequently, a discharge signal for the pixel “n” is generated (rises) in synchronization with (see a broken line a in FIG. 14) rising of the input starting pulse signal for the pixel “n” and falling of a clock signal. Referring to FIG. 13, a high level of the starting pulse signal for the pixel “n” and a high level of the clock signal which is inverted by an inverter 320 are input to an AND gate 321, to generate the discharge signal for the pixel “n”.

Upon generation of the discharge signal for the pixel “n”, a discharge switch 306 illustrated in FIG. 12 is turned on, so that a condenser 307 connected in parallel with the discharge switch 306 is short-circuited and electric charges are drawn. Subsequently, at a rise time of the clock signal (see a broken line β in FIG. 14), the discharge signal vanishes and a charging signal is generated. Referring to FIG. 13, a high level of the starting pulse signal for the pixel “n” and a high level of the clock signal are input to an AND gate 322, to generate the charging signal for the pixel “n”.

As a result of vanishment of the discharge signal, the discharge switch 306 illustrated in FIG. 12 is turned off, to generate the charging signal for the pixel “n”, so that a charging switch 305 is turned on. Then, when the clock signal falls after a predetermined time passes (see a broken line γ in FIG. 14), the charging switch 305 is turned off. During a time in which the charging switch 305 is turned on (charging time), a predetermined amount of electric charges are stored in the condenser 307. FIG. 14 shows how a voltage of electric charges stored for the pixel “n” changes in accordance with a change in the charging signal for the pixel “n”. The predetermined amount of electric charges is determined by the condenser 307, a voltage generated by the photoelectric power generation elements 201, a resistor provided between the photoelectric power generation elements 201 and the charging switch 305, and a charging time.

A voltage of the electric charges stored in the condenser 307 is applied to the liquid crystal 101 via the buffer 304 until a next starting pulse signal is received (for one refreshing period, for example). Then, at the same time as the input starting pulse signal for the pixel “n” falls (see the broken line γ in FIG. 14), an input starting pulse signal for a next pixel “n+1” (which is equal to an output starting pulse for the pixel “n”) is generated in a register 323 illustrated in FIG. 13. Thereafter, the same operations as described above are performed in the pixel “n+1”. More specifically, at a rise time of the clock signal (see a broken line δ in FIG. 14), a discharge signal for the pixel “n+1” vanishes and a charging signal for the pixel “n+1” is generated. When the clock signal falls after a predetermined time passes (see a broken line ε in FIG. 14), the charging switch 305 is turned off. In the waveform diagram of FIG. 14, a charging time for the pixel “n+1” is longer than that for the pixel “n”. Accordingly, a voltage of electric charges stored for the pixel “n+1” is higher than the voltage of electric charges stored for the pixel “n”, as illustrated in FIG. 19.

The same operations as described above are repeated in each of the pixels arranged after the pixel “n+1”, i.e., a pixel “n+2” . . . , sequentially, so that an arbitrary voltage can be applied to each of all the pixels. It is additionally noted that though a voltage of the electric charges stored in the condenser 307 is applied to the liquid crystal 101 via the buffer 304 in the example described above with reference to FIG. 12, a voltage generated by the photoelectric power generation elements 201 can be applied directly to the liquid crystal 101 without including the buffer 304 and the condenser 307 if an adequately long charging time can be given. Also, though an applied voltage is changed using a ratio between a high-level time and a low-level time (duty ratio) of a clock signal while assuming that a clock cycle is constant in FIG. 14, a clock cycle is not necessarily required to be constant.

As is made clear from the above description, the number of gradations can be increased in the liquid crystal display device according to the third preferred embodiment to the same extent as in existing liquid crystal display devices by employing a method in which a plurality of signals are superimposed on a data signal, or the like other method. Additionally, a method for increasing the number of gradations is not limited to the methods described in the third preferred embodiment in the present invention, and the other methods for increasing the number of gradations such as dithering or pulse amplitude modulation can be employed.

### Fourth Preferred Embodiment

In a liquid crystal display device, to continue applying a direct-current (dc) voltage to a liquid crystal would likely cause a phenomenon called “burn-in” of pixels. In order to prevent occurrence of burn-in, alternating-current (ac) drive in which a polarity of a voltage applied to a liquid crystal is inverted with a predetermined cycle, every frame, for example, is performed in a typical liquid crystal display device. Also in the liquid crystal display device according to the present invention, ac drive can be performed in the same manner as in the typical liquid crystal display device.

FIG. 15 illustrates an example of a circuit configuration including the photoelectric power generation elements 201 and the driving circuits 301 according to a fourth preferred embodiment. The photoelectric power generation elements 201 illustrated in FIG. 15 are serially connected with one another so as to obtain a voltage which is twice the maximum voltage applied to the liquid crystal 101, or higher. While three cells of the photoelectric power generation elements 201 are serially connected with one another in the example illustrated in FIG. 3, six cells of the photoelectric power generation elements 201 are serially connected with one another in the example illustrated in FIG. 15.

Referring to FIG. 15, one of the six cells of the serially-connected photoelectric power generation elements 201 which is located in the midst (the third one from the top of the figure) is connected to one of the opposite electrodes of the liquid crystal 101. The liquid crystal 101 is arranged such that a potential of the one of the opposite electrodes which is connected to the photoelectric power generation element 201 is equal to zero and a potential of the other of the opposite electrodes can be arbitrarily (positive or negative) selected by the multiplexer 302. The configuration illustrated in FIG. 15 allows a polarity of a voltage applied to the liquid crystal 101 to be arbitrarily changed, so that ac drive of the liquid crystal 101 can be performed. Control for changing a polarity of a voltage is possible by demodulating the voltage in the same manner as a signal for controlling gradations.

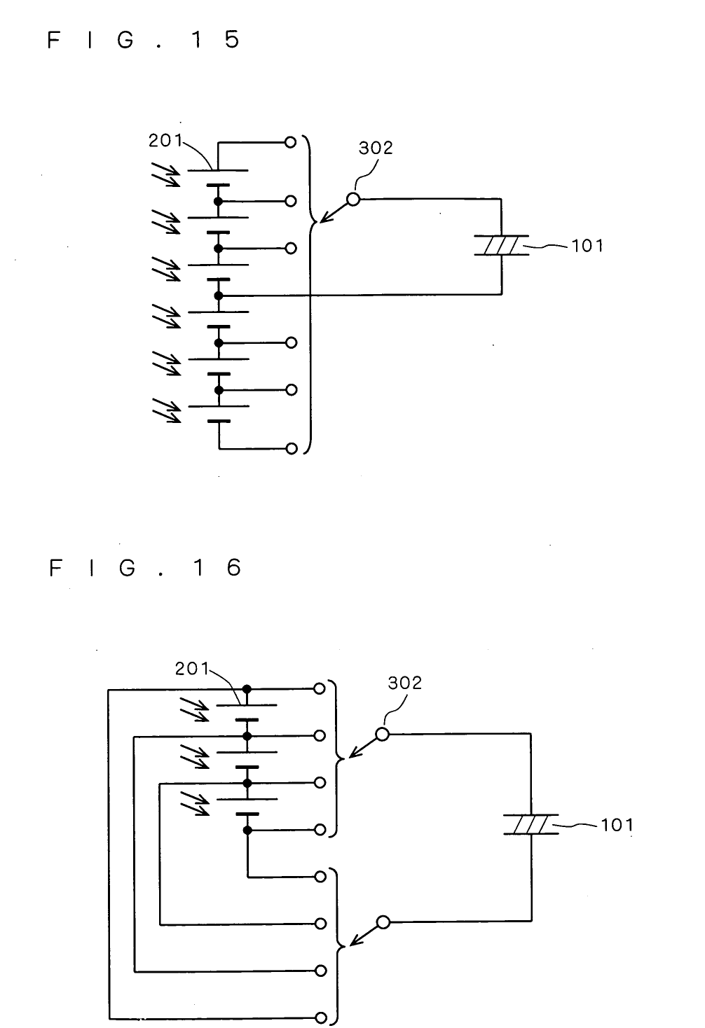

Next, FIG. 16 illustrates an alternative circuit configuration which allows for a change in polarity of a voltage applied to the liquid crystal 101. In the configuration illustrated in FIG. 16, the photoelectric power generation elements 201 are serially connected with one another, and the multiplexer 302 is provided at each of the opposite electrodes of the liquid crystal 101 so as to allow a terminal of each of the photoelectric power generation elements 201 to be connected to either one or the other of the electrodes of the liquid crystal 101. To provide the multiplexer 302 at each of the opposite electrodes of the liquid crystal 101 makes it possible to select an arbitrary potential of each of the opposite electrodes. Thus, a polarity of a voltage applied to the liquid crystal 101 can be changed in accordance with a magnitude order of the respective selected potentials of the electrodes of the liquid crystal 101. It is additionally noted that control for changing a polarity of a voltage can be implemented in combination with control of gradations. Also, the configuration illustrated in FIG. 16 allows reduction in the number and area of the photoelectric power generation elements 201 as compared to the configuration illustrated in FIG. 15.

Further, FIG. 17 is another alternative circuit configuration which allows for a change in polarity of a voltage applied to the liquid crystal 101. The configuration of FIG. 17 is an example intended for reducing the number of the photoelectric power generation elements 201 and the number of the multiplexers 302. In the configuration illustrated in FIG. 17, the electrodes of the liquid crystal 101 are connected to the photoelectric power generation elements 201 with polarity selecting switches 303 being interposed therebetween. Each of the polarity selecting switches 303 is turned on/off by a polarity selecting signal, to change a polarity of a voltage applied to the liquid crystal 101. Selection of gradations is accomplished by selecting any of the serially-connected photoelectric power generation elements 201 using the multiplexer 302. Additionally, the polarity selecting signal can be implemented in combination with a signal for controlling gradations.

As described above, in the liquid crystal display device according to the fourth preferred embodiment, a polarity of a voltage applied to the liquid crystal 101 is inverted with a predetermined cycle, to thereby prevent occurrence of burn-in of pixels.

### Fifth Preferred Embodiment

In the above-described preferred embodiments, the wavelength of light emitted from the light source for control (LED 401) is selected to be different from that of light emitted from the main light source 152 of the back light. However, the present invention is not limited to the above-described preferred embodiments. The main light source 152 can be used as a light source for control in the liquid crystal display device according to the present invention. In a liquid crystal display device according to a fifth preferred embodiment, a structure which allows the main light source 152 to be also used as a light source for control will be described.

In the liquid crystal display device according to the fifth preferred embodiment, the main light source 152 which emits light in a visible light range is used as a light source for control. For this reason, it is preferable that the intensity of light emitted from the light source is constant regardless of pattern of a control signal (white on the entire screen or black on the entire screen, for example). When I×D is kept constant, where I represents a light intensity provided during a lighting time of one light source for control and D represents an average ratio between a lighting time and a non-lighting time (i.e., a duty ratio), a light intensity sensed by human eyes (when white is displayed) becomes constant. Additionally, also in a structure in which a light source for control is provided distinctly from the main light source 152, if a light source for control which emits light in a visible light range is used, it is preferable that the intensity of the light emitted from the light source is constant.

A control signal which is turned alternately on and off with a constant cycle, such as a clock signal, has a constant average light intensity I. On the contrary, with respect to a data signal, there is a need of changing a light intensity I in accordance with a duty ratio D or keeping each of a light intensity I and a duty ratio D constant, in order to keep I×D constant.

In keeping I×D of a data signal constant by changing the light intensity I in accordance with the duty ratio D, a plurality of pieces of image data are temporarily held by a memory, and then, a sum S of some pieces of image data each of which is “1” with the light source for control being turned on in a predetermined time, out of all the pieces of image data held by the memory, is calculated. Then, the duty ratio D is calculated from the sum S. The duty ratio D can be obtained by dividing the sum S by the maximum value that the sum S can take. For example, in a case where twelve bits of image data are provided in a predetermined time, if nine bits of image data become “1” with the light source for control being turned on, the sum S is nine. As the maximum value that the sum S can take is twelve, the duty ratio D is 9/12=0.25.

Thereafter, the light intensity I is determined, and the image data held by the memory is transferred. The light intensity I is determined in proportion to a reciprocal (1/D) of the duty ratio D. However, if the sum S is zero, divergence occurs, resulting in a failure to determine the light intensity I.

Assuming that data transfer is performed with a time during which data is actually transferred (“data transferring time ta”) and a time during which data transfer is halted (“data-transfer halting time tb”) alternately occurring, the foregoing failure can be avoided by lighting up the light source for control at all times during the data-transfer halting time tb. By doing so, the duty ratio D is prevented from taking “zero”, so that the light intensity I can be determined. Further, because of limitation of the maximum value of the light intensity I, it is necessary to appropriately adjust a ratio between the data transferring time ta and the data-transfer halting time tb. The data transferring time ta and the data-transfer halting time tb alternately occur with a cycle of one frame or a cycle of a period required for scanning one line, usually. However, the length of the cycle with which the data transferring time ta and the data-transfer halting time tb alternately occur is not limited to one frame or a period required for scanning one line, and may be a period required for scanning several pixels. Nevertheless, when the length of the cycle is longer than one frame, a speed at which the duty ratio D of the light source for control changes is lower than a frequency which is sensed by human eyes, so that a flicker may probably be perceived.

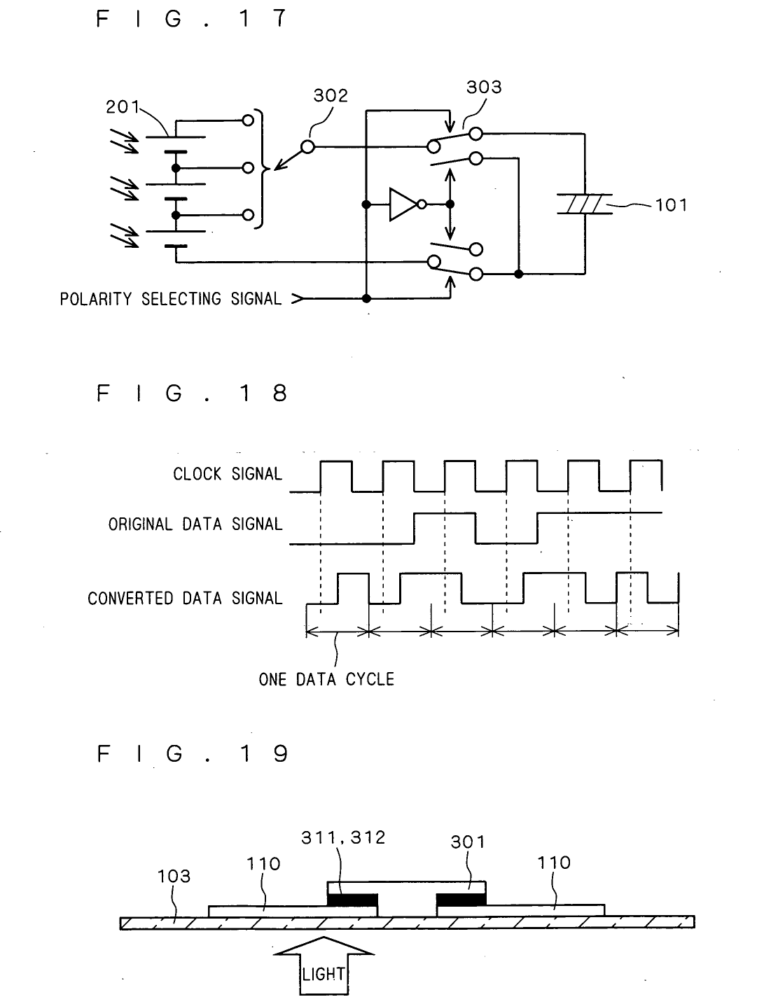

On the other hand, in a case where each of the light intensity I and the duty ratio D of a data signal is kept constant in order to keep I×D constant, image data need not be held by a memory and the light intensity I need not be changed, so that control can be simplified. By toggling a data signal with the same cycle as a clock cycle, it is possible to keep the duty ratio D constant regardless of pattern of a data signal. Specific processes will be described with reference to waveforms in FIG. 18. The waveforms illustrated in FIG. 18 show a clock signal, an original data signal, and a converted data signal obtained by converting the original data signal such that each of the light intensity I and the duty ratio D is constant. Each of respective times during which the converted data signal is in an on-state and an off-state occupies a half of one cycle (“data cycle”, which is identical to a clock cycle) of the converted data signal without fail. Also, a point in time at which the data signal is changed lags behind a point in time at which the clock signal is changed by a quarter of one cycle.

As is appreciated from FIG. 18, the converted data signal enters the same level as the original data signal at a time when the converted data signal is latched (at a rise time of the clock signal in an example illustrated in FIG. 18, which is indicated by broken lines). The converted data signal can be generated using the original signal by placing a data signal in the same state (on-state or off-state) as the original data signal at a time when a quarter of one cycle has passed after a fall time of the clock signal and placing the data signal in a state opposite to the state of the original data signal at a time when a half of one cycle has passed after the time of placing the data signal in the same state as the original data signal (in other words, at a time when three quarters of one cycle have passed after the fall time of the clock signal).

Additionally, the lag of the data cycle behind the fall time of the clock signal is not necessarily a quarter of one cycle. Nevertheless, a longer lag shortens a time for setting up the driving circuit of each of the pixels. To the contrary, a shorter lag disadvantageously shortens a time for holding a voltage applied to the liquid crystal 101. Thus, if the frequency of the clock signal is much lower than a frequency at which the driving circuit of each of the pixels can operate (“operable frequency”), it is possible to adjust a lag within a certain range.

As described above, in the liquid crystal display device according to the fifth preferred embodiment, control is exercised such that a value obtained by multiplying a ratio between a lighting time and a non-lighting time of the light source for control by the light intensity provided in a lighting time is kept constant in a case where a light source which emits light in a visible light range is used as the light source for control or in a case where the main light source 152 is also used as the light source for control. Thus, a light intensity sensed by human eyes is constant, to thereby form a liquid crystal display device free from flickers. Also, an LED having colors such as R, G, and B is used as a main light source of a back light in a common liquid crystal display device in some cases. In such cases, by using the main light source as a light source for control, the number of components for forming a light source can be reduced, to thereby reduce associated costs.

### Sixth Preferred Embodiment

In the fifth preferred embodiment, the structure which allows the main light source 152 of the back light to be also used as the light source for control has been described. In particular, in a case where an LED or the like which emits light having colors such as R, G, and B is used as a light source, the colors can be controlled independently of one another because of a narrow spectrum of the light emitted from the light source. Accordingly, the colors provided by the light source can serve as light sources for different control signals, respectively.

In the above-noted case, a part of a color filter which is used for obtaining a colored image under normal conditions can be used as the filter 313 of each of the optical sensors 311 and 312 provided in the driving circuit 301. FIG. 19 is a sectional view of a liquid crystal display device in which a color filter is used as the filter 313. In a structure illustrated in FIG. 19, color filters 110 are formed on the transparent substrate 103 made of glass and the driving circuit 301 is formed between the color filters 110. It is noted that the transparent electrodes 102 and the like which form the pixels are omitted in FIG. 19 for the purposes of simplification.

Each of the optical sensors 311 and 312 provided in the driving circuit 301 receives light (electromagnetic wave) which has passed through the transparent substrate 103 and the color filters 110. Each of the color filters 110 functions as the filter 313 for selecting light (electromagnetic wave) with a specific wavelength as described above. Thus, when each of the optical sensors 311 and 312 employs the LED 401 which emits R, G, and B as a light source thereof and the color filters 110 each of which transmits one of R, G, and B, for example, red, green, or blue light can be selectively received.

In the structures which have been principally described in the above preferred embodiments, at least two kinds of light sources for generating a clock signal and a data signal, respectively, are needed in order to capture data. Accordingly, there is a need of providing at least two kinds of the optical sensors 311 and 312 in the driving circuit 301 in each of the pixels. However, in the case where the color filter 110 is used as the filter 313 of each of the optical sensors 311 and 312, only one kind of the color filter 110 can be provided in each of the pixels, and it is difficult to provide two kinds of the optical sensors 311 and 312 in each of the pixels.

Also, though it is easy to demodulate monochromatic light to convert the light into data in an ordinary electric circuit, it is practically difficult to demodulate monochromatic light to convert the light into data using the circuit structures described above in each of the pixels of the liquid crystal display device because of a limited area of each of the pixels.

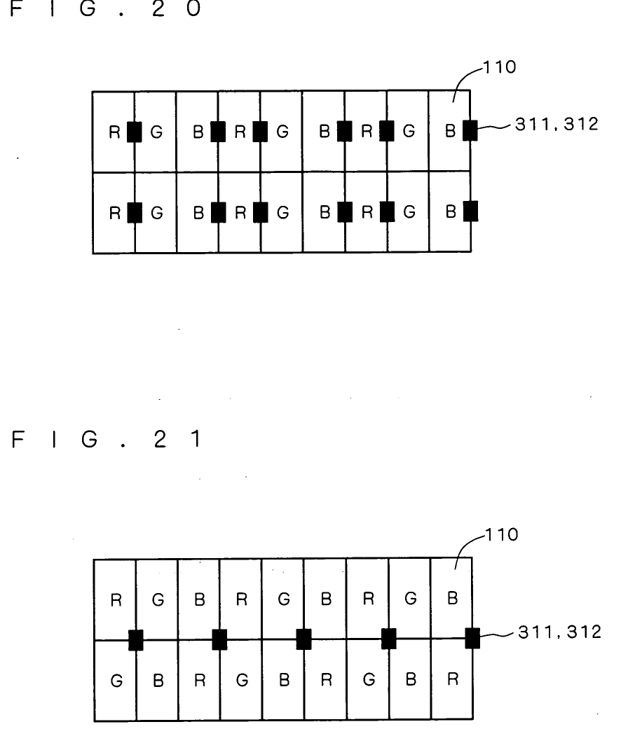

To overcome the foregoing difficulties, the optical sensors 311 and 312 are arranged as illustrated in FIGS. 20 and 21 in a liquid crystal display device according to a sixth preferred embodiment. In FIG. 20, the optical sensors 311 and 312 are placed on a border between two adjacent pixels so that two kinds of color filters 110 located adjacent to each other are shared by the two pixels. Further, in FIG. 21, the optical sensors 311 and 312 are placed on a joint of four adjacent pixels so that four kinds of color filters 110 located adjacent to one another are shared by the four pixels.

Additionally, a plurality of pixels are not necessarily required to share the optical sensors 311 and 312. However, in a case where a plurality of pixels do not share the optical sensors 311 and 312, outputs of the optical sensors 311 and 312 placed in one pixel must be transmitted to an adjacent pixel using a line. For this reason, in the case where a plurality of pixels do not share the optical sensors 311 and 312, a whole structure is complicated and an operable frequency is probably reduced due to signal delay under influence of a line capacity or the like.

As described above, a part of the color filter 110 is used as the filter 313 of each of the optical sensors 311 and 312 in the liquid crystal display device according to the sixth preferred embodiment. This eliminates a need of additionally providing the filter 313, to thereby reduce associated costs.

While the invention has been shown and described in detail, the foregoing description is in all aspects illustrative and not restrictive. It is therefore understood that numerous modifications and variations can be devised without departing from the scope of the invention.

What is claimed is:

1. A liquid crystal display device comprising:
a first substrate;
a second substrate placed opposite to said first substrate;
a liquid crystal held between said first substrate and said second substrate;
plural driving circuits respectively provided in plural pixels on said first substrate, for driving said liquid crystal; and
plural photoelectric power generation elements respectively provided for either said plural pixels or plural sets each including some of said plural pixels, for generating power and supplying a voltage to drive said liquid crystal.

2. The liquid crystal display device according to claim 1, wherein
said plural photoelectric power generation elements are placed near openings of said plural pixels.

3. The liquid crystal display device according to claim 1, wherein
each of said plural photoelectric power generation elements has a predetermined color and is a light-permeable thin film, and
said plural photoelectric power generation elements are placed on openings of said plural pixels.

4. The liquid crystal display device according to claim 1, further comprising
plural electromagnetic-wave sources for control which supply an electromagnetic wave used for controlling said plural driving circuits, wherein
said plural driving circuits include a demodulator for demodulating said electromagnetic wave.

5. The liquid crystal display device according to claim 4, wherein
said electromagnetic wave has a wavelength in a range from ultraviolet to infrared.

6. The liquid crystal display device according to claim 5, wherein
said plural electromagnetic-wave sources for control are included in a back light, and
said electromagnetic wave and light emitted from a main light source of said back light are mixed with each other in an optical waveguide of said back light.

7. The liquid crystal display device according to claim 5, wherein
said plural electromagnetic-wave sources for control are included in a front light, and
said electromagnetic wave and light emitted from a main light source of said front light are mixed with each other in an optical waveguide of said front light.

8. The liquid crystal display device according to claim 4, wherein
said electromagnetic wave has a wavelength in an invisible light range other than a visible light range.

9. The liquid crystal display device according to claim 4, wherein
each of said plural electromagnetic-wave sources for control functions also as a main light source.

10. The liquid crystal display device according to claim 9, wherein
a ratio between a lighting time and a non-lighting time of each of said plural electromagnetic-wave sources for control is constant.

11. The liquid crystal display device according to claim 9, wherein
a value obtained by multiplying a ratio between a lighting time and a non-lighting time of each of said plural electromagnetic-wave sources for control by a light intensity provided in said lighting time is constant.

12. The liquid crystal display device according to claim 4, wherein
each of said driving circuits includes a filter for selectively transmitting a specific wavelength range of said electromagnetic wave, and
each of said driving circuits is controlled based on said electromagnetic wave which passes through said filter.

13. The liquid crystal display device according to claim 12, wherein
said filter includes a part of a color filter used for obtaining a colored image.

14. The liquid crystal display device according to claim 12, wherein
said electromagnetic wave includes at least a clock signal serving as a timing for driving said plural driving circuits and a data signal written into said plural pixels, and
each of said plural driving circuits separates at least said clock signal and said data signal from said electromagnetic wave using said filter.

15. The liquid crystal display device according to claim 12, wherein
said electromagnetic wave includes at least a clock signal serving as a timing for driving said plural driving circuits, and
said plural driving circuits control a voltage applied to said liquid crystal based on a length of either a high-level time or a low-level time of said clock signal.

16. The liquid crystal display device according to claim 14, wherein
said plural driving circuits transmit a starting pulse signal serving as a timing for writing said data signal into said plural pixels, to said plural pixels except a predetermined pixel, using a line laid between said plural pixels.

17. The liquid crystal display device according to claim 14, wherein
plural signals are superimposed on said data signal.

18. The liquid crystal display device according to claim 1, wherein
said plural driving circuits invert a polarity of a voltage applied to said liquid crystal with a predetermined cycle.

19. A large scale liquid crystal display system comprising
plural liquid crystal display devices which are tiled, wherein
each of said plural liquid crystal display devices includes:
a first substrate;
a second substrate placed opposite to said first substrate;
a liquid crystal held between said first substrate and said second substrate;
plural driving circuits respectively provided in plural pixels on said first substrate, for driving said liquid crystal; and
plural photoelectric power generation elements respectively provided in either said plural pixels or plural sets each including some of said plural pixels, for generating power and supplying a voltage to drive said liquid crystal.
